(19) United States
(12) Patent Application Publication
(10) Pub. No.: US 2008/0253322 A1
(43) Pub. Date: Oct. 16, 2008

(54) WiMAX Multicast Broadcast Network System Architecture

(75) Inventors: Tricci So, San Diego, CA (US); Jianquan Song, ShenZhen (CN); Li Chu, ShenZhen (CN); Zhongyu Gu, Nanjing (CN)

Correspondence Address: FISH & RICHARDSON, PC, P.O. BOX 1022, MINNEAPOLIS, MN, 55440-1022, US

(73) Assignee: ZTE (USA) INC., Iselin, NJ (US)

(21) Appl. No.: 12/041,647

(22) Filed: Mar. 3, 2008

Related U.S. Application Data
(60) Provisional application No. 60/904,630, filed on Mar. 2, 2007.
(60) Provisional application No. 60/893,079, filed on Mar. 5, 2007.
(60) Provisional application No. 60/979,811, filed on Oct. 13, 2007.
(60) Provisional application No. 60/979,982, filed on Oct. 15, 2007.

(51) Int. Cl. H04Q 7/00

(52) U.S. Cl. 370/329

(57) ABSTRACT

Techniques and system architectures for supporting Multicast Broadcast Services (MCBCS) over a WiMAX network.

### CROSS-REFERENCE TO RELATED APPLICATIONS

This application claims the priorities and benefits of the following four U.S. Provisional Applications:

1. Ser. No. 60/904,630 entitled “Multicast Broadcast Services (MBS) over Wireless Communication Networks” and filed on Mar. 2, 2007;

2. Ser. No. 60/893,079 entitled “Multicast Broadcast Services (MBS) over Wireless Communication Networks” and filed on Mar. 5, 2007;

3. Ser. No. 60/979,811 entitled “WiMAX Multicast Broadcast Network System Architecture” and filed on Oct. 13, 2007; and

4. Ser. No. 60/979,982 entitled “WiMAX Multicast Broadcast Network System Architecture” and filed on Oct. 15, 2007.

The contents of the above patent applications are incorporated herein by reference.

### BACKGROUND

This application relates to wireless communications.

Wireless communication systems provide voice or data services to subscriber stations or mobile stations (e.g., wireless or mobile stations) situated within a geographic region by dividing the region into a number of cells. Each cell may be further divided into two or more sectors. Each cell contains system communication equipment such as a base station that transmits communication signals to fixed or mobile subscriber stations on the forward link and receives communication signals from the subscriber stations on the reverse link. One exemplary wireless communication system designed for high speed packet data services is 1×EV-DO, which is also known as High Date Rate (HDR) or High Rate Packet Data (HRPD) system. 1×EV-DO has been standardized as C.S0024 in the international standard group Third Generation Project Partnership Two (3GPP2). Prior published standards include IS-856 Revision 0, Revision A and Revision B standards. Another example of wireless communication systems is wireless networks based on WiMAX (wireless interoperability for microwave access) technology based on IEEE 802.16 standards (e.g., IEEE 802.16e).

Wireless networks can be used to provide both point-to-point communication services and multicast and broadcast services. Multicast services allow unidirectional point-to-multipoint transmission of data, such as multimedia data that may include one or more types of data such as text, audio, picture, video and others. Such unidirectional point-to-multipoint transmission can be directed from a single source point to a multicast group of subscriber stations. The 3GPP2 MBMS (Multicast and Broadcast Service) is an example of such multicast broadcast services over 3G networks.

### SUMMARY

This application provides, among others, techniques and system architectures for supporting Multicast Broadcast Services (MCBCS) over a WiMAX network. In one aspect, an implementation of a multicast broadcast service (MCBCS) WiMAX communication system includes at least one MCBCS access network (ASN) that includes (1) base stations to provide radio access to one or more MCBCS clients, (2) an ASN gateway (ASN-GW); (3) an MCBCS Access Agent entity which provides signaling, establishing, and tearing down bearer channels for MCBCS clients, and (4) an MCBCS Local Agent entity to organize a respective local base station resource management function to support the MCBCS Access Agent entity to coordinate system resource allocation and airlink scheduling support. This system also includes a Connectivity Services Network (CSN) comprising a MCBCS controller that provides functions for MCBCS user service provisioning and delivery, a MCBCS subscriber profile manager that manages MCBCS subscriber profiles, a MCBCS subscriber profile database, and AAA functions that provide authentication, authorization and accounting functions. The MCBCS controller delivers MCBCS content data to a MCBCS client requesting a MCBCS service.

In another aspect, an implementation of a multicast broadcast service (MCBCS) WiMAX communication system includes at least one MCBCS access network (ASN) comprising (1) base stations to provide radio access to one or more MCBCS clients, and (2) an ASN gateway (ASN-GW) comprising at least one MCBCS Access Agent entity which provides signaling, establishing, and tearing down bearer channels for MCBCS clients. Each base station includes an MCBCS Local Agent entity to organize a respective local base station resource management function to support the MCBCS Access Agent entity to coordinate system resource allocation and airlink scheduling support. This system also includes at least one Connectivity Services Network (CSN) comprising a MCBCS controller that provides functions for MCBCS user service provisioning and delivery, a MCBCS subscriber profile manager that manages MCBCS subscriber profiles, a MCBCS subscriber profile database, and AAA functions that provide authentication, authorization and accounting functions; and an interface in communication with one or more MCBCS content providers with MCBCS servers that serve MCBCS content data to the MCBCS controller.

These and other aspects of techniques and system architectures for supporting Multicast Broadcast Services (MCBCS) over a WiMAX network are described in greater detail in the drawings, the detailed description and the claims.

### BRIEF DESCRIPTION OF DRAWINGS

FIGS. 1A and 1B illustrate examples of wireless WiMAX network designs that provide Multicast and Broadcast Services (MCBCSs).

FIG. 2 illustrates examples of various logical functions in a Multicast and Broadcast Service Controller (MBSC) as shown in FIGS. 1A and 1B.

FIG. 3 shows a comparison between an exemplary broadcast service and an exemplary multicast service in a WiMAX system shown in FIGS. 1A and 1B to show commonalities and differences for the Service Provisioning Procedures between Broadcast and Multicast Modes support for MCBCS.

FIG. 4 shows an example of the MCBCS User Service Registration Procedures.

FIG. 5 shows an example of the MCBCS User Service De-registration Procedures.

FIG. 6 shows an example of the MCBCS User Service Activation.

FIG. 7 shows an example of the MCBCS User Service De-activation.

FIG. 8 shows an example of the MCBCS Content Transmission Session Start (Resource Allocation).

FIG. 9 shows an example of the MCBCS Content Transmission Session Stop (Resource De-allocation).

FIG. 10 shows an example of the MCBCS Content Transmission Session Update for the Broadcast Mode.

FIG. 11 shows MCBCS data synchronization based on the WiMAX macro diversity.

### DETAILED DESCRIPTION

The emerging Multicast Broadcast services are considered an important part of the fourth generation (4G) wireless convergence network services. According to the WiMAX Service Provider Working group that defines the Multicast Broadcast Services (MCBCS) for WiMAX network, implementations of MCBCS can be used to efficiently provide a common content to multiple users. MCBCS can be implemented by using IEEE802. 16e MBS feature and a suitable IP networking solution can be provided to enable MCBCS over the WiMAX access network. This application discloses examples of system architectures for supporting Multicast Broadcast Services (MCBCS) over the WiMAX network.

MCBCS can be categorized into Multicasting or Broadcasting Services. In the Multicast Service in MCBCS, users may dynamically join and leave a Multicast IP session and the system may monitor the number of users at each MCBCS Zone to decide on data transmission and its mode. In the Broadcast Service in MCBCS, the content is always transmitted through broadcast channels by the access network without considering the number of mobile subscriber stations (MSs) that receive the broadcast content from the baste stations. Given these two possible modes of the MCBCS operation, there are two service layers to support MCBCS: MCBCS subscription management, and MCBCS transport management. The MCBCS subscription management can include functions for delivering application contents to many MCBCS subscribers (e.g. news, audio and video clips etc.), supporting user authentication and authorization, accounting, management of the quality of service (QoS), and supporting the data confidentiality and privacy. The MCBCS subscription management functions can be built on different transport technologies that support IP multicast. The MCBCS transport management can be implemented to provide the IP multicasting support for MCBCS subscriber, maintain a one-to-many data distribution tree information to the MCBCS transmission zone, and provide the transport-layer accounting support.

The present WiMAX MCBCS network solutions can be implemented in ways that efficiently use the existing radio resource and re-use the existing core network infrastructure in existing 3G networks to enable the WiMAX MCBCS services. The deployment of the present WiMAX MCBCS network solutions can be based on design considerations related to optimal radio access network resource sharing among unicast, multicast and broadcast services, and among different wireless Network Service Providers (NSPs). Effective and efficient roaming support can be used to provide an important criteria to promote MCBCS services among WiMAX Network Access Providers (NAPs), NSPs and Content Providers (CPs) as well as Application Service Providers (ASPs).

Due to the complexity of the MCBCS service requirements and the nature of different network components and infrastructure involved to support the MCBCS services, the existing WiMAX standard, such as WiMAX NWG Release 1.0 architecture, need be updated to support MCBCS services. Therefore, the BS, Access Service Network (ASN) Gateway and the Connectivity Serving Network (CSN) in existing WiMAX standards can be modified to support MCBCS services. Because the transport is to support the multicast and broadcast services, the present designs provide multicast transport over the WiMAX network infrastructure.

### 1. Wireless WiMAX Network Architecture for Multicast and Broadcast Services

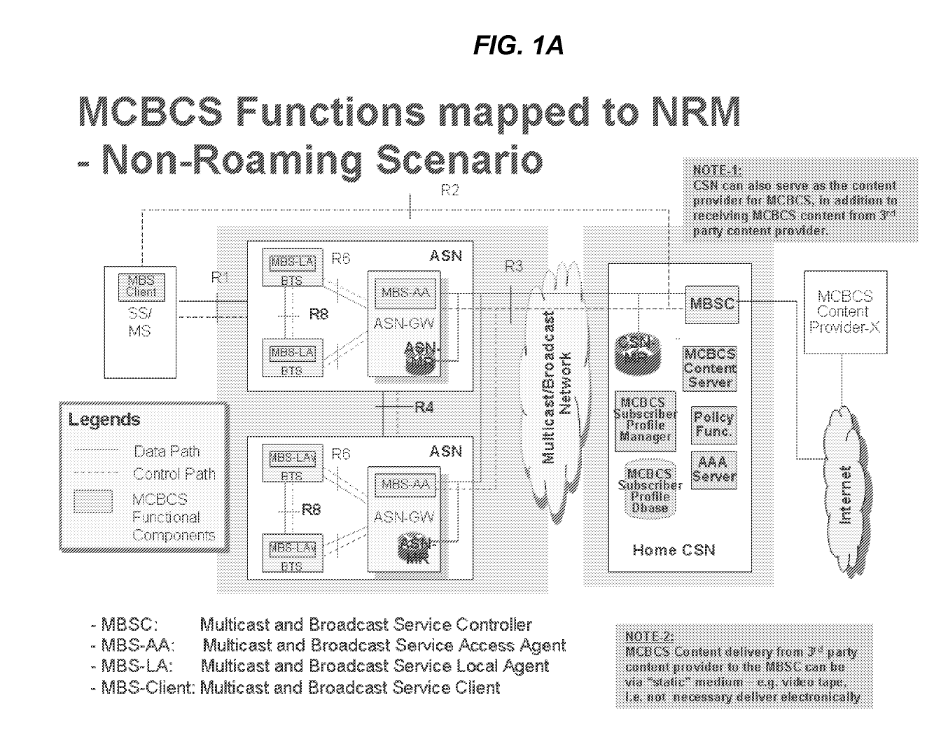

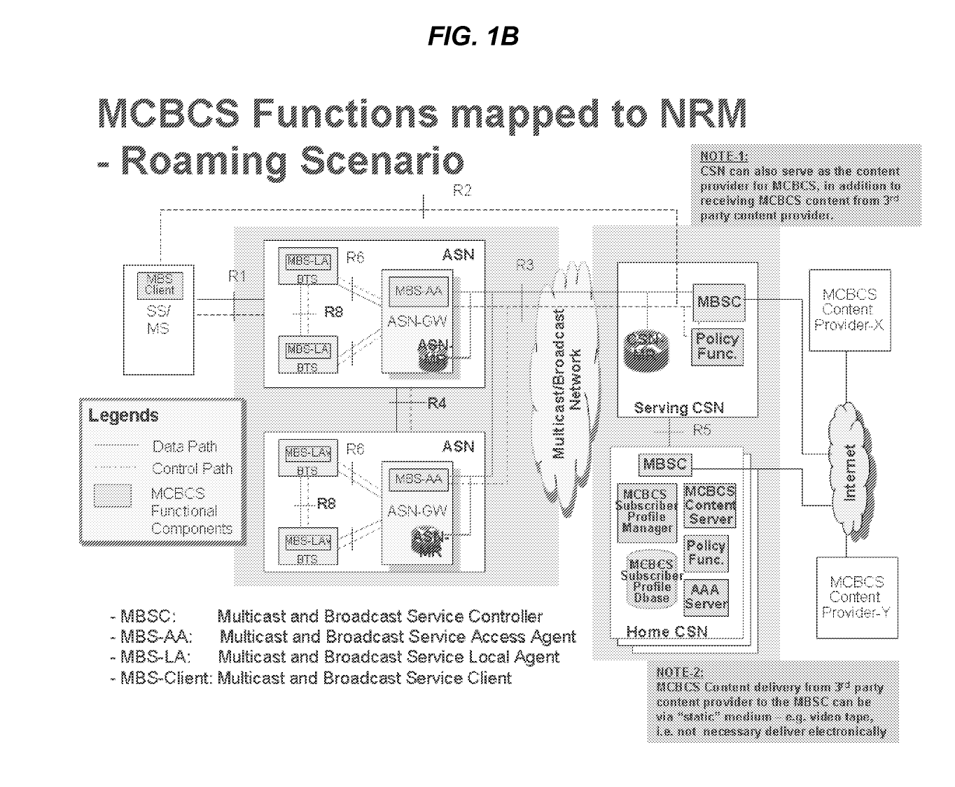

FIG. 1A shows an example of a wireless WiMAX network design that provides Multicast and Broadcast Services (MCBCSs). The system includes a network of base stations (BSs) or base transceiver stations (BSTs) that are spatially distributed in a service area to form a radio access network for wireless subscriber stations (SSs) or Mobile Stations (MSs). A SS or MS may be any communication device capable of wirelessly communicating with base stations and may be implemented as a mobile SS or a fixed SS which may be relocated within the system. Examples of a stationary wireless device may include desktop computers and computer servers. Examples of a mobile wireless device may include mobile wireless phones, Personal Digital Assistants (PDAs), and mobile computers. A base station in the system is a radio transceiver that is conceptually at a center of a cell and wirelessly communicates with a MS in the cell via downlink radio signals. Each BS may be designed to have directional antennas and to produce two or more directional beams to further divide each cell into different sections. Base station controllers (BSCs) are provided in the system to control the BSs. Each BSC is connected to a group of two or more two or more designated BSs and controls the connected BSs. One or more ASN Gateway (GW) units are provided in each ASN to control the BSCs and the corresponding BSs. As illustrated, the wireless WiMAX network can include at least one ASN and may include two or more ASNs. Each ASN is connected to a carrier IP network which carries, among other data, various data for the MCBCS services shown as “multicast/broadcast network” in FIG. 1A. The wireless WiMAX network in FIG. 1A also includes a Connectivity Serving Network (CSN) for WiMAX communications. The CSN is connected to the multicast/broadcast network. Optionally, the wireless WiMAX network in FIG. 1A can be structured to support multihop relay (MR) base stations that expand the radio coverage of the radio access network. The ASN can include one or more ASN-MR servers and the CSN can include one or more CSN-MR servers.

The MCBCS functions in the wireless WiMAX network in FIG. 1A are provided as logical functions inside the ASN and a MCBCS Controller (MBSC) in the CSN. In this regard, the ASN can include one or more MBS Local Agent (LA) functions and MBS Access Agent (AA) functions that manage and control the radio access for a MS with respect to MCBCS functions. For example, the MBS-AA can be implemented in one or more ASN-GWs and the MBS-LA can be implemented in one or more BTSs. The MBSC in the CSN can be configured to provide MCBCS content for serving MCBCS requests from MSs by (1) retrieving and routing desired MCBCS contents from one or more third-party MCBCS content provider servers outside the CSN, (2) retrieving desired MCBCS contents in one or more content servers inside the CSN, and (2) a combination of (1) and (2).

### MCBCS Controller (MBSC)

the MBSC provides functions for MCBCS user service provisioning and delivery. It may serve as an entry point for the MCBCS content provider to enable MCBCS content transmissions. MBSC is responsible for coordinating with the MCBCS content network to schedule the reception of the MCBCS contents. MBSC is also responsible for authorizing the incoming contents from the MCBCS content server, and initiating the MCBCS downlink transmission towards the WiMAX access network. For example, the MBSC can include the following logical functions: MCBCS subscription and group management function, Content session management and delivery function (including content integrity support), MCBCS bearer control and relay function (including the bearer context management and bearer context synchronization with MBS-AA at the ASN), Service discovery and announcement function, MCBCS access control function, and MCBCS transmission zone management

### MBS-Client

The MBS client refers to MCBCS capable MS. This entity is responsible for performing the MCBCS Information Acquisition, MCBCS service/subscription registration, and MCBCS content reception.

### MCBCS Access Agent (MBS-AA)

This MBS Access Agent logical entity is responsible for signaling, establishing, and tearing down bearer channels between the MBSC and the MSs by interfacing with the anchor data path (DP) entity and anchor SFA (service flow authorization) of the MS as well as with ASN-MR. The MBS Access Agent may be located in a single MBS-GW or two or more MBS-GWs.

The MBS-AA is responsible for coordinating multiple MCBCS transmissions within and across the MCBCS transmission zones synchronously with the support of the system and radio resource management function which considers the optimization of RF and core network resources as well as the required QoS, etc. In addition, if header compression is enabled for the MCBCS service, this MBS-AA can also support the header compression operation.

In addition, the MBS-AA can also support the MCBCS transmission zone management coordinated by the MBSC.

### MCBCS Local Agent (MBS-LA)

This MCBCS Local Agent local entity is responsible for organizing the local Base Station (BS) resource management function to support the MBS-AA to coordinate the system resource allocation and airlink scheduling support for the MCBCS transport. The MBS-LA may be located in a BS.

FIG. 1A shows a system where a MBS-client is served by its home CSN. FIG. 1B further shows a system where a MBS-client roams out of the server region of its home CSN and is served by a serving or visiting CSN which may be a CSN by the same network service provider or a CSN from another network service provider. If the current serving or visiting CSN supports the MCBCS services provided by the home CSN, the current serving or visiting CSN can communicate with the home CSN to route the MCBCS service content to the roaming MS. If the current serving or visiting CSN does not support the MCBCS services provided by the home CSN, the requested MCBCS services are then temporarily suspended until a MCBCS-supporting serving CSN is found by the roaming MS. As illustrated in FIG. 1B, the MCBCS-supporting serving CSN can communicate with the home CSN to obtain the MCBCS service information for the requesting MS and then retrieve the MCBCS content from the appropriate MCBCS content provider server(s) and deliver the MCBCS content data to the requesting MS.

Within the MBS architecture, the following reference points (RPs) can be used for communication interfaces between different network entities:
R1 Interface
   Based on IEEE 802.16e specification
   MBS airlink session creation/maintenance/deletion
   MBS power efficient reception—support MS in Sleep and Idle modes
   Mobility, etc.
R2 Interface
   Support MCBCS service discovery, subscription registration and contents announcement (e.g. via HTTP)
   Security association establishment (i.e. authentication, authorization and key management) for MCBCS service grant Authentication and Contents Protection
   Respond to the MCBCS service control signaling and determine the MCBCS contents selection (i.e. MBS service selection/change/remove—e.g. via RTSP)
   Coordinate with MBSC to support MCBCS service authentication and authorization, and key Management
   Support MCBCS statistic collection, content delivery confirmation and retransmission
R3 Interface
   For MCBCS session control
      MCBCS service registration from MBS-AA to MBSC and service authentication and authorization between the MBSC and MBS-AA
      MCBCS bearer context establishment and synchronization
      MCBCS session management
         MCBCS notifies the beginning/termination of a MCBCS session. Session attributes like MCBCS Content ID and Name, multicast IP and port etc. download from MBSC to MBS-AA.
      MCBCS QoS Management
      MCBCS Transmission Zone Management
   For MCBCS subscriber management
      Subscriber session authentication, authorization, commencement (e.g. multicast-join), termination
      MCBCS subscription context synchronization between MBSC and MBS-AA triggered by subscriber session operation (i.e. joint, release)
      Proxy signaling to support distributed MBSC functions across multiple ASNs
R5 Interface
   Roaming support for MCBCS bearer control and subscriber management —communication is between visiting and home MBSCs
   The roaming subscriber requires the home MBSC authentication and authorization in order to be served by the visiting MBSCs (note: not necessary applies to all MCBCS user classes)
   Proxy signaling to support distributed MBSC functions to select an appropriate ASN for the subscriber to access the MCBCS service which is aiming for optimizing routing, resource saving and operator policy.
R6/R4/R8 Interface
   Synchronization and transmission of MCBCS datagram
   MBS zone management and maintenance
   Multicast tree graft and pruning
   User mobility and MBS zone advertisement
   MBS connection establishment and maintenance—coordinated with Service Flow Agent via Service Flow Manager, Paging Controller via Paging Agent
   Macro Diversity support for MBS—initiated and controlled by the MBS-AA that coordinates with MBS-LA to interface with ASN Datapath Function via the support of IP Unicast and IP Multicast (IGMPv2/3) between the ASN and CSN and to the MBS Content Network.

The features for the WiMAX systems in FIGS. 1A and 1B can use the common MS and backend core network system capability to support both WiMAX and 3GPP2 Multicast/Broadcast services, to enable the WiMAX Multicast/Broadcast Access Agent (MBS-AA) function at the WiMAX access service network (ASN) to dynamically discover the Multicast/Broadcast Controller (MBSC) in the backend core network, and allow a MS to directly communicate with the Multicast/Broadcast Content Server (MBS Server) for service registration, authentication and authorization as well as programming content information acquisition.

### 2. MCBCS Functional Descriptions

In general, the WiMAX ASN and CSN work cooperatively to support the MCBCS bearer transport services. However, not all the functional entities described below are specific designed for MCBCS except for the MBSC functions. MBSC provides the bearer transport service, and the subscriber management such as service provisioning and delivery to the MCBCS subscribers.

2.1 MCBCS Controller (MBSC)

The MBSC is one of the MCBCS functional entities and provides functions to support the MCBCS subscriber management such as service provisioning and delivery. The MBSC is also acting as the gateway for the MCBCS content provider to download the MCBCS contents. The MBSC is responsible to initiate the MCBCS bearer transport for a given MCBCS transmission zone within or across the ASN(s) and coordinate with the ASN to schedule the MCBCS content download to the MBS-AA that serves the MBS zone within the WiMAX network.

The MBSC is responsible to for authenticating and authorizing the MCBCS subscribers to access the MCBCS contents. Once the MCBCS subscriber is authenticated and authorized to access the MCBCS content at the local ASN, the MBSC can then set up the MCBCS bearer context for the given subscriber and such information can also be passed onto the ASN to establish the MCBCS user context.

The key functions provided by the MBSC are:
MCBCS subscription and group management function—applicable only to the multicast mode operation
Content session management and delivery function (including content integrity support)
MCBCS bearer control and relay function (including the bearer context management and bearer context synchronization with MBS-AA at the ASN)—applicable only to the multicast mode
Service discovery and announcement function
MCBCS access control function—applicable only to the multicast mode operation
MCBCS transmission zone management

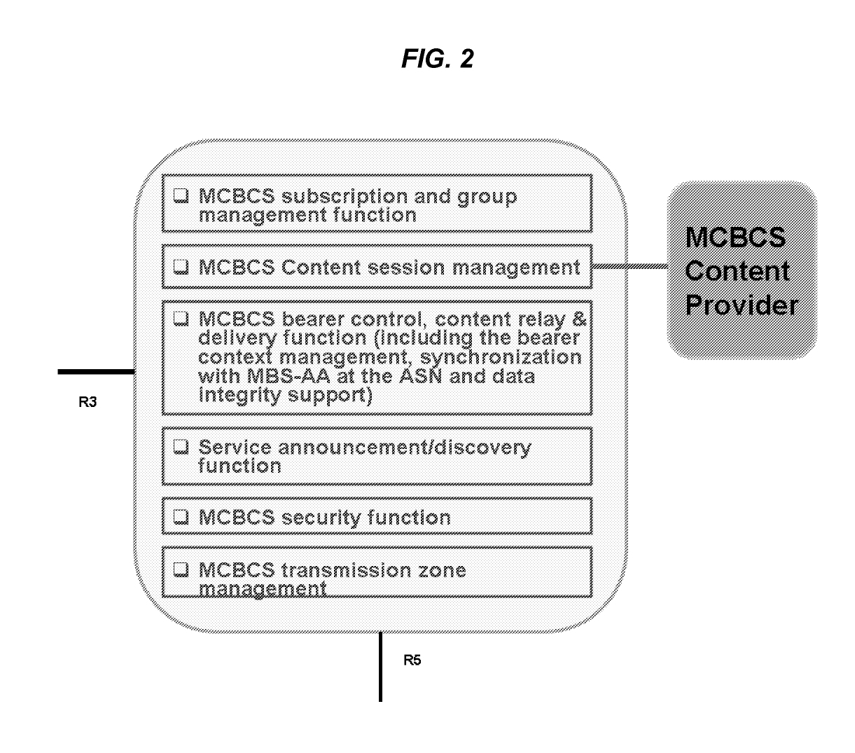

FIG. 2 examples of logical functions of the MBSC.
2.1.1. MCBCS Service Announcement/Discovery

This function is designed to support the MCBCS session communication between the MBSC and the MCBCS subscriber for both the multicast or broadcast operations. The intent is to allow the MCBCS subscriber to request or to be informed about the range of the MCBCS user services that are available for the given ASN.

The service announcement includes
the information provided by the MBSC to the MCBCS subscriber mobile station (MS) regarding the media type descriptions (e.g. type of video and audio encodings), and
the MCBCS session descriptions identifying the MCBCS sessions to be delivered to the MS, e.g.
   MCBCS service identification and/or content name,
   MCBCS content description,
   IP multicast address and/or port id,
   Content Program Schedule (i.e. Start time, End time and allowed registration time),
   Transport protocol (e.g. RTP/UDP etc.),
   QoS parameters (e.g. bandwidth)
   Application Protocol (e.g. MPEG4 etc.),
   Security parameters
   Packet processing information, e.g.
      Encryption Type—Link layer or Higher Layer Encryption,
      Header Compression Information—Algorithm (e.g. ROHC U mode etc.) and configuration parameters.

The announcement sent towards the MS via ASN may be triggered by MBSC, but not necessarily sent by the MBSC, and the mechanism to send the announcement can be implemented by, e.g., operating the MBSC to directly signal to the MBS-AA to broadcast the MCBCS user services; by using URL via WAP or HTTP, and by SMS point-to-point messaging. The choice of the above mechanisms may be made based on the user's location and thus the interaction with the Location Based Service (LBS) function may be needed. User who have not already subscribed to the MCBCS service should also be able to discovery the MCBCS user services.
2.1.2. MCBCS Subscription and Group Management Function

The subscription and group management function provides the authentication and authorization for the MCBCS subscriber who requests the MCBCS service. Based on the MCBCS bearer service context, it can generate the MCBCS subscriber context which can then be passed onto the ASN to derive the MCBCS user context. The Subscription and Group Management function may also generate the accounting records for the MCBCS subscriber.
2.1.3. MCBCS Content Session Management

Towards the Content Provider side, the MBSC can authenticate and authorize the external sources prior to the acceptance of the content source from the Content Provider, if the content source is dynamically downloaded from the content network. Alternatively, the contents can be provided to the MBSC via manual intervention, e.g. storage disk.
2.1.4. MCBCS Service Policy Control, Content Relay & Delivery Function and Bearer Control

This logical function provides the Policy Control function to determine the local MCBCS service policy to deliver the MCBCS contents, and acts as a content relay function to send the MCBCS contents received from the Session Management Function to the ASN.

Once the content source is received from the Content Provider, the MBSC can coordinate with the ASN to schedule the MCBCS content download for each broadcasting or multicasting session and may be separate unicast sessions for all MSs who are entitled for receiving the MCBCS contents. Each of the transmission session can be associated with the MCBCS Session Identifier that is unique within the system so that the MCBCS subscriber mobile station (MS) can recognize the retransmission, if it is required.

Each transmission and subsequent re-transmission(s) of a specific MCBCS session are identifiable by a common MCBCS Session Identifier which is passed at the application layer in the content, and can also be included in the MCBCS Session Start Request message to the ASN. The full MCBCS Session Identifier should be used by the MS to identify the MCBCS session when completing the point-to-point session transmission repair, while the full or partial portion of the MCBCS Session Identifier is used by the ASN in the session notification message for the given MCBCS content.

Based on the local ASN's service policy, the MBSC can also provide the ASN the transport bearer associated parameters such as the QoS parameters and the MCBCS transmission zone (i.e. the geographical service coverage area of the MCBCS contents transmission).

The MBSC can support the network resource initialization controlled by the ASN including the RF resource allocation prior to the scheduled transmission to the ASN. Likewise, the MBSC can support the de-allocation of the network resource controlled by the ASN after the scheduled transmission is completed. The support of the Forward Error Correction is feasible.

This function is responsible for managing the multicast distribution tree to support the MCBCS bearer transport, and the multicast payload that is to be sent to the ASN. This function is also responsible for the bearer context management and the support of the multicast/broadcast downlink transmission synchronization with the MBS-AA at the ASN for the given MCBCS content.

Another bearer control function is to support unicast-and-multicast (or broadcast) airlink transport switching (i.e. switching from the unicast to multicast (or broadcast), or from the multicast (or broadcast) to unicast over the airlink) for the MCBCS multicast and broadcast mode operation. This function allows the optimization of the airlink resource by considering the number of the MCBCS subscribers which are subscribed to the same MCBCS contents within the same coverage area of the same group of BSs, and reaching certain the radio resource consumption which may include the power level of the BSs as well as the MSs, and the modulation encoding etc., these information can be collected by the MBSC from the MS to derive the actual system resource utilization trade-off between the unicast and multicast (or broadcast) transport. The information is then forward by the MBSC to the ASN to process in order to schedule the unicast-and-multicast (or broadcast) airlink transport switching operation.
2.1.5. MCBCS Security Function

The function described is referring to the MCBCS subscriber protection and is designed to support the MCBCS subscription and group management function described earlier. The MCBCS subscriber may leverage the MCBCS security function for the data integrity and/or confidentiality protection of the received MCBCS content. MBSC security function is also used to derive the MCBCS Broadcast Access Key (BAK) which can then be distributed to the authorized MS which has the proven credential to obtain the BAK.
2.1.6. MCBCS Transmission Zone Management (Service Coverage Area Management)

This function manages the MCBCS contents to be delivered to the one or more MCBCS transmission zones. Each of these zones includes multiple BSs within the WiMAX network. All MSs can access to the same MBS channel in the same zone via the same 802.16 multicast connection. Note that all BSs within the same MBS zone share the same key for encrypting the same MBS contents. All BSs which are serving the same MCBCS service coverage area may have the downlink transmission synchronized up to the RF symbol accuracy over the same frequency, so that the MS can continue to receive the downlink transmission seamlessly. This reduces substantially the handoff delay between the BSs which are belonged to the same MCBCS Transmission zone. Hence, in this particular example, the MBSC is required to be aware of which BS belonged to which MCBCS Transmission Zone.

2.2 MCBCS Access Agent (MBS-AA) and ASN Gateway (ASN-GW)

The MBS-AA is a group of logical functions that manage and control the local access network resource allocation, and coordinate the network elements to support the ASN bearer transport of the MCBCS contents to the MCBCS subscribers. In addition, the MBS-AA enforce the MCBCS service's QoS performance at the local access network. The list of MBS-AA logical functions are described in the following.

The role of the MBS-AA in the MCBCS architecture is to serve as an entry point for the IP multicast traffic to receive the MCBCS contents. Upon the notification from the MBSC, or via static configuration, the MBS-AA can establish the bearer plane to support the broadcast or multicast MCBCS transmission. Likewise, upon the notification from the MBSC, or static configuration, the ASN-GW can tear down the bearer plane to terminate the broadcast or multicast MCBCS transmission.

The ASN Gateway is the leave node of the MCBCS content distribution tree and provides the IGMP proxy function on behalf of the MS to support the MCBCS content distribution tree rooted at the MBSC. The MCBCS user service activation and de-activation are triggered by the MS's IGMP joint and IGMP release message respectively.

The anchor datapath function at the ASN that is designated for the given MCBCS transmission session can receive the MCBCS specific IP multicast traffic which can then be redirect to the corresponding unicast R6 and/or R4 tunnels that are destined to the BSs belonged to the same MCBCS transmission zone for the given MCBCS contents.

Prior to the anchor datapath function to transmit the MCBCS contents towards the BSs, the MBS synchronization functional entity at the MBS-AA can leverage the MBS content synchronization protocol to synchronize all the BSs within the same MCBCS Transmission Zone with timing and framing airlink scheduling information to support the synchronized radio transmission.

The MBS-AA is responsible to collect all the MCBCS related radio resources information to feed into the MBS-AA MCBCS airlink scheduling function that is mentioned above and to support the radio resource management within and across the MCBCS transmission zones.

The MBS-AA can also support the intra-ASN and inter-ASN mobility procedure to store the user-specific MCBCS user context for each activated MCBCS bearer service and to pass on the context to support the mobility procedure as well as to support the power saving procedure for MCBCS.

The MBS-AA should also be determined of which MS is still actively associated with the given MCBCS transmission.

The MBS-AA can support the MCBCS user context synchronization with the MBSC.

The MBS-AA can support the generation of the accounting record per MCBCS multicast bearer transport for each MCBCS subscriber.

The MBS-AA can coordinate with the dedicated anchor datapath function which is specific to a given MCBCS content to establish the MCBCS bearer transport upon receiving a session start from the MBSC; likewise, the MBS-AA can coordinate with the dedicated anchor datapath function to tear down the MCBCS bearer transport upon receiving a session stop from the MBSC.

2.3 MCBCS Local Agent (MBS-LA) and BS Functions

The MBS-LA is a group of logical functions which are resided at the BS and are responsible for interfacing with the radio resource management locally at the BS as well as interfacing with the MBS-AA at the ASN-GW via the support of the MBS content synchronization protocol to provide an efficient MCBCS scheduling to delivery of the MCBCS contents synchronously to the MSs for the given MCBCS transmission zone. The MCBCS contents synchronization refers to the operation of all BSs that are belonged to the same MCBCS Transmission Zone are all synchronized to transmit the same MCBCS content using the same TDD/FDD frame (i.e. frame level synchronization) and may be even synchronized in the same OFDMA data region using the same channel coding scheme (i.e. symbol level synchronization). The result of such precision of coordination function enables the macro diversity effect which provides a much higher transmission quality of the contents to the subscriber even at the cell edge of the coverage area.

The MBS-LA supports the MCBCS content synchronization operation controlled by the MBS-AA that may support simple recovery of BS's radio processing in case of packets-loss during data distribution towards the BS, however, without the need of any feedback/retransmission channel. Prior to distribution of content on the radio interface, various techniques e.g. concatenation and segmentation, are assumed to ensure most efficient utilization of radio resources. If MCBCS content synchronization operation is supported, all BSs which are belonged to the same MCBCS Transmission Zone are configured to taking part in the Single Frequency Network (SFN) and/or Multi-carrier operations to ensure transmission of identical MCBCS content data for SFN and/or Multi-carrier operations within or across the MCBCS Transmission Zones.

The MBS-LA can support the MCBCS airlink scheduling control decision made by the MBSC to schedule the MCBCS airlink transmission. The MBS-LA can support the initiation and termination of the MCBCS transmission by the MBSC. Similar to other mobile services, the MBS-LA can cope with data loss caused by the MS mobility to maintain the MCBCS operation.

2.4 MCBCS Client and MS Functions

The MCBCS client resided at the MS supports the activation or de-activation of the MCBCS bearer transport and maintains the MCBCS user context that is related to the MCBCS session content. Once the MCBCS bearer transport is activated, no need for further explicit request from the MS is required to receive the MCBCS contents; however, the MS may be further notified that the MCBCS session transmission is about to start. The MCBCS client can interface with the MBSC to support the MCBCS security function. The MCBCS client can receive the MCBCS announcement to discover the MCBCS contents; in addition, it can register with multiple MCBCS contents and receive multiple downlink transmissions from different MCBCS contents. The MCBCS client can report to the MBSC regarding the loss of the MCBCS transaction during the content download and also be able to support the retransmission from the MBSC. The MCBCS client may receive the periodic MCBCS session notification which contains the MCBCS Session Identifier. Based such information, the MCBCS client can decide to accept or to ignore the forthcoming MCBCS transmission.

Notably, the MS can monitor the airlink protocol over the R1 interface, MBS MAP descriptor IE which is one per MBS zone. The MS accesses the Down Link (DL) MAP over the R1 to initially identify MBS zones and locations of the associated MBS MAPs in each zone. The MS can then subsequently read the MBS MAPs without reference to DL MAP unless synchronization to MBS MAP is lost or the transmission schedule of the next sequence of MCBCS content data is ready to be announced to the MCBCS subscribers (i.e. MSs). The MBS MAP IE specifies MBS zone PHY layer configuration and defines the location of each MBS zone via the OFDMA Symbol Offset parameter. The MBS MAP is located at the 1st sub-channel of the 1st OFDM symbol of the associated MBS zone. The IEEE 802.16e feature of multi-BS MBS does not require the MS to continuously register with every BS during the mobility once the MS has been associated with a MBS zone. MCBCS content can be accessed when MS in Idle mode to allow low MS power consumption.

### 3. MCBCS System Attributes and Parameters for MCBCS Policy Control and Management Support

There are two main types of MCBCS related context: MCBCS Bearer Context and MCBCS User Context

3.1 MCBCS Bearer Context

The MCBCS bearer context is referred as the MCBCS service profile that can be supported by the wireless access network to support MCBCS. It describes the transport characteristics of the bearer that are used to deliver MCBCS data.

The MCBCS bearer context can be generated at the ASN when the very first MCBCS user context is created for the given MCBCS content. MCBCS bearer context is maintained by the anchor data path of the MCBCS bearer transport for a given MCBCS content. The trigger mechanism of the MCBCS bearer context generation is the MCBCS Session Start and the MCBCS bearer context enters to the active state. When the MCBCS bearer context is in the “active” state, it implies the given MCBCS bearer plane resources are used by the network to serve the MCBCS transmission session. This state is maintained as long as there is corresponding MCBCS session ongoing. Likewise, when the ASN receives the MCBCS Session Stop, the MCBCS bearer context can then enter to “in-active” state which implies the given MCBCS bearer plane resources is not needed at the moment at the ASN. This state is maintained as long as there is no on-going MCBCS session. Eventually, when the last MCBCS user context for the given MCBCS content is deleted from the ASN, the MCBCS bearer context can be deleted as well. The MBSC maintains the MCBCS bearer context for the given MCBCS content by the MBSC's Bearer Control and Relay function as long as there is a service agreement for the wireless network to support the given MCBCS content.

In general, the MCBCS bearer context can include the following set of information: Multicast mode or broadcast mode operation; IP multicast address of the MCBCS bearer; Address of the Anchor ASN of which the anchor datapath of the MCBCS bearer associated with the above IP multicast address; QoS parameters; MCBCS Transmission Zone; List of associated ASN for given MCBCS Transmission Zone; and Number of subscribers associated with the multicast group (for Multicast mode only).

3.2 MCBCS User Context

The MCBCS user context contains the user specific MCBCS content subscription information related to a particular MCBCS bearer service that the MS has joined. The MCBCS user context is created in the MS, ASN-GW as well as in the MBSC's subscription and group management function. When the MS is moving from one ASN to another ASN and is re-anchored to the new ASN, the MCBCS user context is transferred as well. When the very first MCBCS user context is created for the MS during the MCBCS service activation for the MS, some information of the MCBCS user context is provided to the BS to be stored as part of the MS context. Notably, one MCBCS user context is provided for MCBCS content session for the given MS.

In general, the MCBCS user context can include the following set of information: IP multicast address of the MCBCS bearer; Address of the Anchor ASN of which the anchor datapath of the MCBCS bearer associated with the above IP multicast address; Routing area identity; MS's identity; and R6/R4 tunnel endpoint identity.

### 4. Multicast and Broadcast Modes Service Provisioning

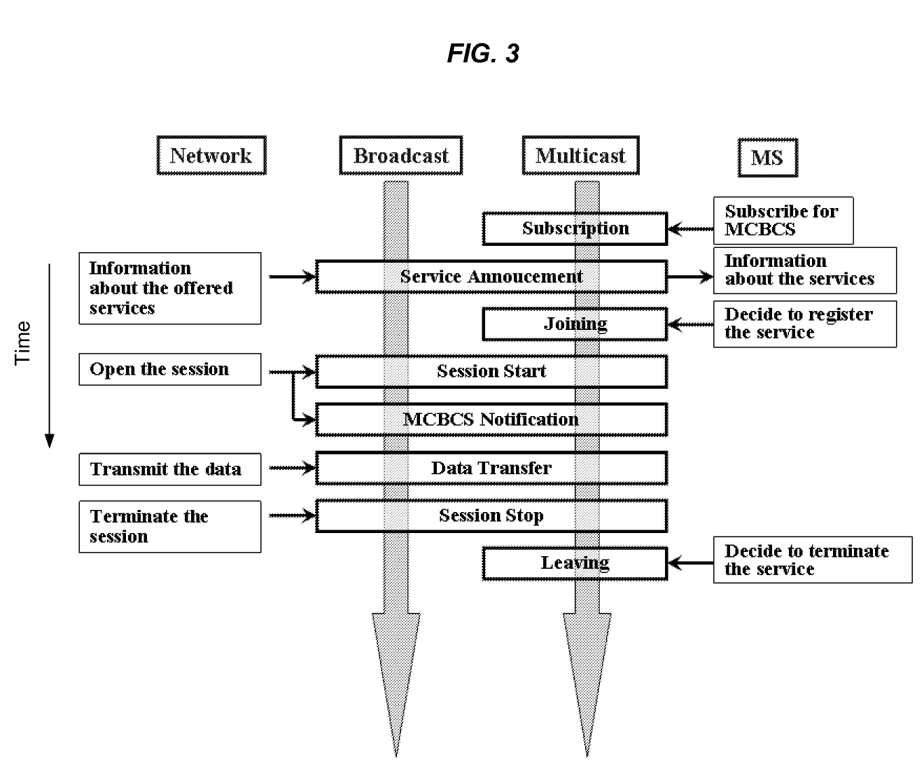

The reception of the multicast and broadcast transmission for MCBCS content session is enabled by a specific set of service provisioning procedures. In general, there are commonality and differences for the service provisioning procedures between the multicast and broadcast modes operation. FIG. 3 summarizes the commonalities and differences of each stage of these service provisioning procedures. Further details can also be provided to explain the design of these procedures to support the multicast and broadcast modes transmission.

4.1 Multicast Mode Procedures

During the multicast mode transmission, the phase “subscription”, “joining” and “leaving” are procedures that apply to an individual MS's operation. The other phases, i.e. “service announcement”, “session start”, “notification”, “data transfer” and “session stop” are procedures that apply to all MSs which are impacted by the MCBCS service.
4.1.1 MBSC Discovery

In general, two MBSC Discovery approaches can be provided: Static MCBCS Service Discovery and Dynamic MCBCS Service Discovery. In the Static MCBCS Service Discovery, the MBSC's server IP address or identifier (FQDN) may be provisioned in the MS's MCBCS Client (e.g OTA service provisioning directly to the mobile terminal). Such static configuration is more appropriate for the stationary and nomadic deployment (e.g. concert hall, football stadium, race track etc.). The Dynamic MCBCS Service Discovery can be used to leverage the DHCP IP configuration capability via DHCP DISCOVERY, REQUEST or INFORM message to obtain the address of the MBSC. In addition, the Dynamic MCBCS Service Discovery can be used to leverage the DHCP IP configuration capability via DHCP DISCOVERY, REQUEST or INFORM message to obtain the FQDN of the MBS.
4.1.2 Subscription

The main target of MCBCS Subscription phase is to establish the relationship between the subscriber and the service provider. After the subscription, the user is allowed to receive the related MCBCS multicast service, and the service provider/operator is allowed to charge subscriber about the received MCBCS multicast service

The MCBCS service subscription can be made by various mechanisms, e.g. by the Internet, and by visiting the service provider's sale office etc. The MCBCS service subscription is not required for the MCBCS broadcast mode.
4.1.3 Service Announcement/Discovery

MCBCS service announcement/discovery mechanisms allow users to request or be informed about the range of MCBCS user services that are supported by the network.

MCBCS service announcement is used to distribute to users the information about the service and parameters for the service activation, e.g. IP multicast address(es), ASN Identifier (not NAP ID), service start time, available media formats etc.

Two methods can be used for supporting the service announcements: “pull” method in which the initiative comes from the receiving MS and the “push” method in which the initiative arises from the service itself. In the case of a pull method, the devices fetch the announcements (HTTP or WAP) from a web server. In the push method, SMS (Short Message Service) cell broadcast, SMS-PP (point-to-point), WAP-PUSH, MCBCS broadcast, MCBCS multicast and MMS (Multimedia Message Service) are used. The method chosen to inform users about MCBCS services may account for the subscriber's location (i.e. LBS support). The mobile subscriber (MS) who have not already subscribed to the MCBCS service should also be allowed to receive the MCBCS service announcement.

When the MS receives the MCBCS user service information, which indicates that the service is protected (e.g. the service protection description is present in the Service Announcement), and the user wants to receive the MCBCS user service, the MS can register to the MCBCS user service irrespective of the type of the MCBCS transmission mode—i.e. broadcast vs. multicast. The registration is necessary to ensure the MS who is the valid subscriber receives the necessary MSK and all subsequent MSK updates. If the MCBCS user service does not require any protection (e.g. the service protection description is not present in the Service Announcement), the MS does not perform user service registration for the key management purpose.
4.1.4 Joining—Service Activation

For each active “multicast” service, all involved functional elements (i.e. MS, MBS-LA, MBS-AA and MBSC) create a MCBCS user context for the MS. When a functional element creates the first MCBCS user context for a MS for a particular service, it creates additionally the “associated” MCBCS bearer context. If a MS wants to receive a particular service, it has to join the multicast group that it can extract from the service announcement.

Once the information is obtained, the MS sends out an IGMP (Internet Group Management Protocol, IPv4) or MLD (Multicast Listener Discovery, IPv6) join message. The devices create the necessary MCBCS user and bearer contexts after they are authorized by the MBSC. When a user does not want to receive a service anymore, the MS sends out an IGMP/MLD leave message to the network. In a mobile communication network, the users' mobility must be taken into account, so that the group membership information at the MBSC needs to be updated whenever the recipients move to other BSs.

Joining can be performed under one of the following conditions: just before the service reception, long before the service reception (i.e. a week, days etc), and upon active MCBCS service on-going transmission. Because the joining can be used as a ground for charging, the subscriber must be authenticated and the authorization of the joining must be confirmed by operator/owner of the service subscription. Joining is required only in the Multicast mode and is unnecessary in the Broadcast mode.
4.1.5 Session Start—Resource Reservation

When the MBSC is ready to transmit data to the ASN, it transmits a Session Start message to the MBS-AA. The MBS-AA in turn informs the corresponding MBS-LAs in the BSs which are part of the MCBCS transmission zone for the incoming MCBCS contents about the forthcoming transmission. The MBS-LAs reserve the necessary resources to support the MCBCS content transmission. In all involved network elements, the MCBCS bearer context for the activated service is set to the “active” state. When data transmission is finished, the MBSC sends out a “session stop” message to the MBS-AA, which also relays the operation event to the involved MBS-LAs. The MBS-LAs release the reserved resources. In all involved network element, the MCBCS bearer context for this service is changed to the “standby” state.

Session Start occurs independently of activation of the MCBCS service triggered by the user (i.e. IGMP Join) as a user may activate the service before or after Session Start. Session Start is the trigger for the bearer resource establishment for the MCBCS data transfer.
4.1.6 MCBCS Notification

The mechanism informs the MSs about the on-going availability or forth-coming availability of a specific MCBCS downstream data of a given cell. It is basically can be used to notify the MS as the indication of another phase of the downstream transmission. The key requirements are as follows:
MCBCS notification can be transmitted within the MCBCS Transmission Zone.
MCBCS notification can be sent so it could be received by all MSs with an activated MCBCS service, regardless of the operation state in any of the MSs.
MCBCS notification should maximize the reuse of existing MCBCS radio resources.
MCBCS notification should allow terminals to minimize their power consumption, meaning that MSs with an activated MCBCS service should not listen permanently, but at regular intervals to MCBCS notification.
Reception of MCBCS notification cannot be guaranteed.
MSs may receive MCBCS notification and simultaneously monitor other occasions, e.g. MS dedicated paging.

WiMAX offers the MCBCS notification over R1, however, such function available only for the multi-BS MBS transport.
4.1.7 Data Transfer

This process is referred to the downstream data transmission. In the case of the broadcast mode, there is no encryption or any possibility of retransmission. However, in the case of the multicast mode, the data can be protected and retransmission may be provided.
4.1.8 Session Stop (Resource De-Allocation)

When the MBSC is ready to terminate the transmission of the data, it transmits a Session Stop message to the MBS-AA. The MBS-AA in turn informs the corresponding MBS-LAs about the termination of the transmission. The MBS-LA de-allocate the necessary resources that has been assigned to the MCBCS content session. In all involved network elements, the MCBCS bearer context for the activated service is set to the “inactive” state. In all network elements, the MCBCS bearer context for this service is changed to the “in-active” state.
4.1.9 Leaving (De-Activation)

This is the process by which a subscriber leaves (stops being a member) a multicast group, i.e. the user no longer wants to receive Multicast mode data of a specific MCBCS service.

Leaving from the MCBCS group doesn't mean the termination of a subscription. Leaving should be possible to perform before, during and after the MCBCS service reception. Leaving may require subscriber authentication. Leaving is possible to made only through point-to-point connections. Leaving is required only in Multicast mode.

4.2 Broadcast Mode Procedures

The applicable procedures, which are “Service announcement,” “session start,” “notification,” “data transfer” and “session stop,” have similar system behavior as the multicast mode procedures.

An addition procedure, Session Update, is only applied to the MCBCS broadcast mode operation and is designed to update specific system operation parameters of the ongoing MCBCS broadcast. The system operation parameters include (1) an update of the MCBCS Transmission Zone, and/or (2) a list of the ASNs belonged to the same MCBCS Transmission Zone.

If the Session Update is regarding the change to the list of the ASNs, it can result in triggering the “Session Start” to be sent to the new ASN which has joined the MCBCS Transmission Zone; and triggering the “Session Stop” to be sent to affected ASNs.

### 5 MCBCS Security

This section describes features for the MCBCS security in the systems in FIGS. 1A and 1B.

5.1 MCBCS Service Registration & De-Registration
5.1.1 MBSC Operation Requirements

The MBSC can perform authentication and integrity protection if the MS registers with the MCBCS service. The MBSC can use HTTP digest and can follow RFC 2616 and RFC 2617 to authenticate and to authorize the MS's request.

Upon receiving the HTTP Post from the MS without an authorization header, if the MBSC decides that authentication and integrity protection is required, and a valid nonce is not available in the MBSC, the MBSC can send a AAA accept request message to the Home AAA Server of the MBS content server to request a nonce.

Upon receiving the AAA access challenge from the Home AAA server, the MBSC can send HTTP 401 Unauthorized with a WWW-Authenticate Header to the MS including digest challenge.

Upon receiving the HTTP Post from the MS with an authorization request header included, the MBSC can send a AAA access request message to the Home AAA Server to obtain the authentication attributes information to authenticate the MS.

Upon receiving a AAA access accept message from the Home AAA Server including Digest and key materials, the MBSC can compute auth-info to authenticate the MS. The MBSC can send a 200 Ok with authentication-info header. The MBSC can set message-qop to “auth-int”.

The MBSC can include the message authenticator information in the authentication message. The AAA access accept message, including the MBS attribute(s) without a message authenticator attribute can be silently discarded by the MBSC. The MBSC supporting the MCBCS attributes can validate the message authenticator and can silently discard the packet if the validation is failed.
5.1.2 Home AAA Server Operation Requirements

Upon receiving a AAA access request message from the MBSC, the Home AAA Server can follow enforce the authentication of the MS by checking whether the MS is allowed to subscribe to MCBCS service. For authentication purpose, the Home AAA server can compute Auth-Key and use it as password of the subscriber. Upon successful authentication and authorization, the Home AAA Server can compute the encryption key materials to the MBSC.

The Home AAA server can include a message authenticator in the AAA access accept message. The AAA access accept message, including the MBS attribute(s) without a message authenticator attribute can be silently discarded by the MBSC. Otherwise, the MBSC can validate the message authenticator and can silently discard the packet if the validation is failed.
5.1.3 MS Operation Requirements

If the MS receives an HTTP 401 Unauthorized with a WWW-Authenticate Header from the MBSC in response to a MS's MCBCS service activation or de-activation request, the MS can compute Auth-Key and perform HTTP digest procedures and resend HTTP Post with an authorization request header included, as specified in RFC 2617, with password set to the Auth-Key.

Upon receiving 200 OK with authentication-info header from the MBSC, the MS can check response digest. Upon successful check, the MS can process the HTTP body; otherwise, the MS can ignore the message.

5.2 Key Management

Registration Key (RK) is the basis of the key distribution and authentication for MBS. RK is specific to the MS and provisioned in both the device and the Home AAA prior to the service. A Temporary encryption Key (TK) is derived from the RK and the TK_RAND by the Home AAA, sent to the MBSC and subsequently used by the MBSC to encrypt the BAK when the MBSC distributes the BAK to the MS during MCBCS Service Activation. BAK provides access to a particular set of MCBCS contents for a certain amount of time (for example, one day, week or month). Each encrypted set of MCBCS contents may have a different BAK value. The Short-term Key (SK) is used by the MBSC (for higher layer encryption) or by the ASN (for link layer encryption) to encrypt the MCBCS flow and by the MS to decrypt the MCBCS flow. The SK is derived from SK_RAND and BAK.

5.3 Encryption

The Content Encryption function encrypts MCBCS content. If link layer encryption is used, the content encryption function is located in the ASN. If higher-layer encryption is used, the content encryption function is located MBSC.
5.3.1 Link Layer Encryption and Higher Layer Encryption

Encryption can be provided at the link layer. If higher layer encryption is enabled, SRTP (RFC 3711) can be applied and the Content Encryption (CE) function can be in the content server. The SRTP Session Encryption Key can be used as the SK to encrypt the MCBCS content. The SRTP Master Key, SRTP Master Salt, and Packet Index are used for deriving the SRTP Session Encryption Key and Session Authentication Key according RFC 3711 which depicts the SRTP key derivation. The key derivation occurs in the MS device.

The SRTP encryption transform can be the AES in Counter Mode.

### 6 Header Compression

Both the MBSC and the MS optionally support the ROHC U Mode header compression algorithm.

The MCBCS Service Announcement/Discovery between the MBSC and the MS are used to convey the header compression configuration parameters.

After the MS discovers the MBSC's address, the MS acquires the MCBCS session related information, including whether header compression is used and the header compression configuration parameters.

The header compression configuration parameters are required by the specific header compression algorithm chosen. The header compression configuration parameters for ROHC U mode are listed as follows:
LARGE_CIDS: Boolean, indicates whether large CID (0˜16383) or small CIDs (0˜15) are used.
MAX_CID: Nonnegative integer, indicates the maximum CID used, constrained by the choice of LARGE_CIDS. If it does not have the capability to handle the number of contexts indicated by MAX_CID, the MS may still accept the header compression configuration because it may only be interested in a subset of MBS streams and thus does not need to maintain all the contexts.
Profile: Nonnegative integer, indicates the compression profile used. The profile ID for RTP profile is 0x0001.
MAX_HEADER: Nonnegative integer, indicates the maximum header size in octets that can be compressed. The suggested value is 168.
MRRU: Nonnegative integer, indicates the size of the largest reconstructed unit in octets that the decompressor is expected to reassemble from segments. Value 0 means that no segment headers are allowed on the channel.

When ROHC U mode is used, the BSN and MS follow RFC 3095. The MBSC sends IR packets at initialization and sends IR and IR-DYN at periodic refresh.

6.1 MS Operation Requirements

When the MS receives the MBS session related information from the MBSC, the MS checks whether the header compression algorithm is supported or not. If the header compression algorithm is supported, the MS can store the header compression configuration parameters and can follow ROHC U mode as specified in RFC 3095.

6.2 MBSC Operation Requirements

During the MCBCS Service Announcement/Discovery, the MBSC can indicate to the MS whether header compression is used or not. If ROHC U mode header compression is used, the MBSC can also include the configuration parameters required for the ROHC U mode header compression.

The MBSC can configure the header compressor according to the configuration parameters received and perform header compression for the multicast IP flow when the multicast IP flow is received from the content server.

If ROHC U mode is used, the CSN-MR can follow RFC 3095. The MBSC can indicate the header compression protocol in use for the corresponding MCBCS content transmission. The MBSC can initialize the compressor by sending IR packets to the MS. In addition the MBSC can periodically send IR and IR-DYN packets to refresh the static and/or dynamic context as specified in RFC 3095. The refresh periods are configurable by the operator.

If the MBSC does not support the header compression, it can ignore the header compression configuration parameters and send IP packets without header compression.

### 7. MCBCS Highlevel System Procedures

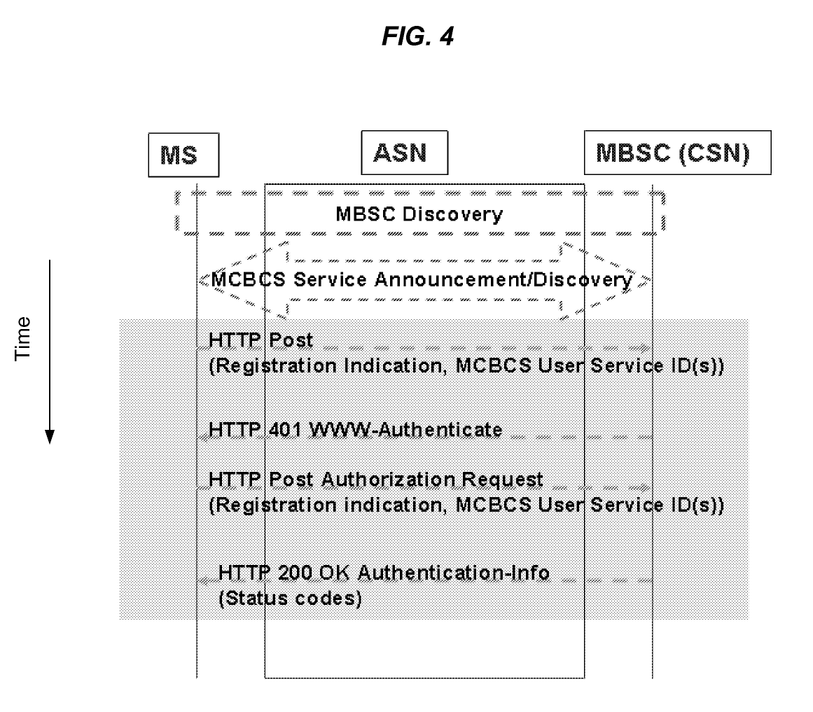

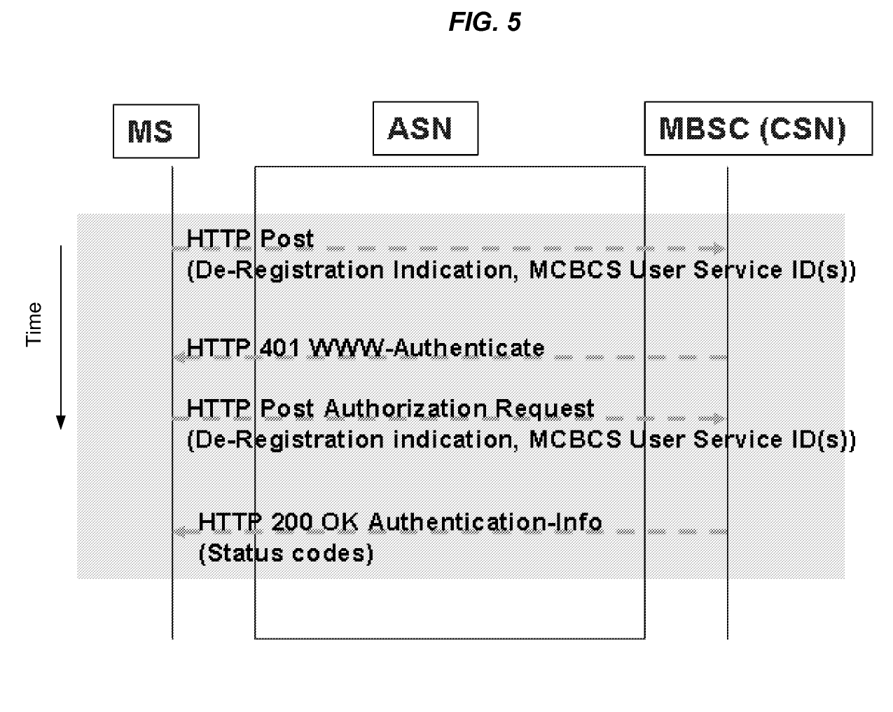

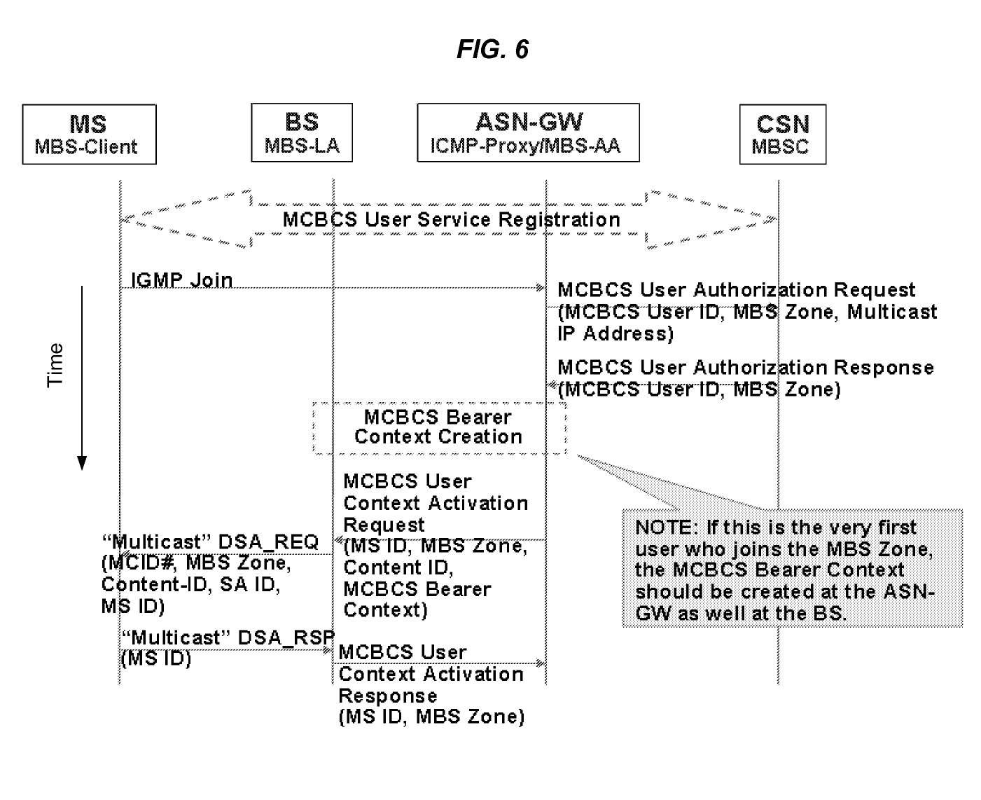

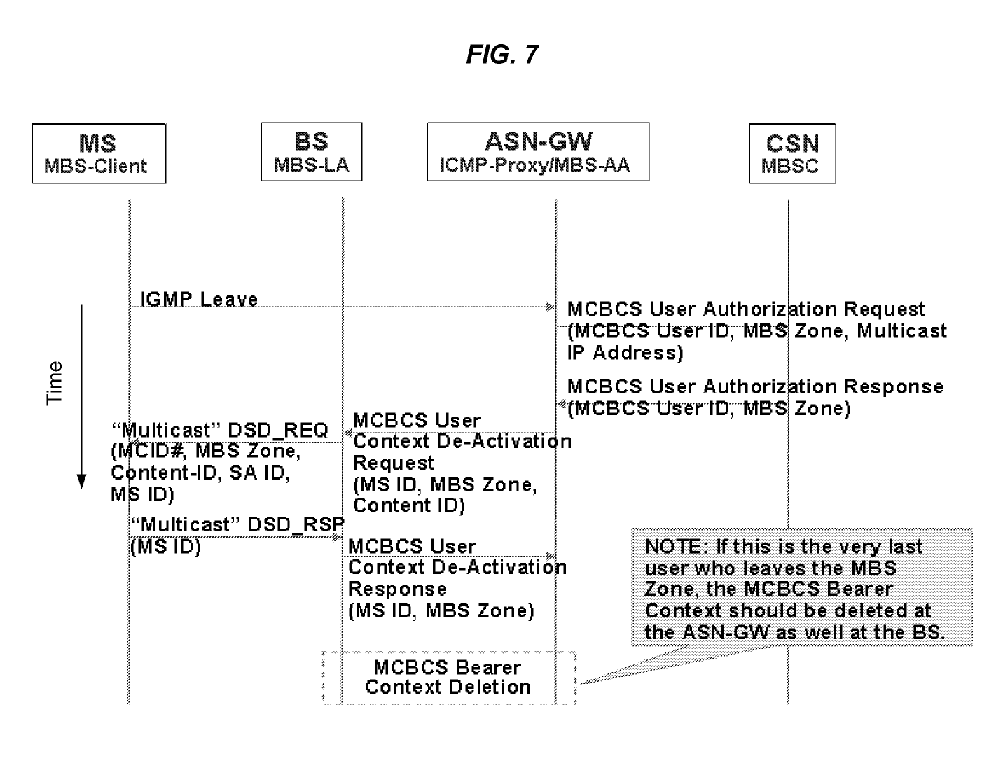

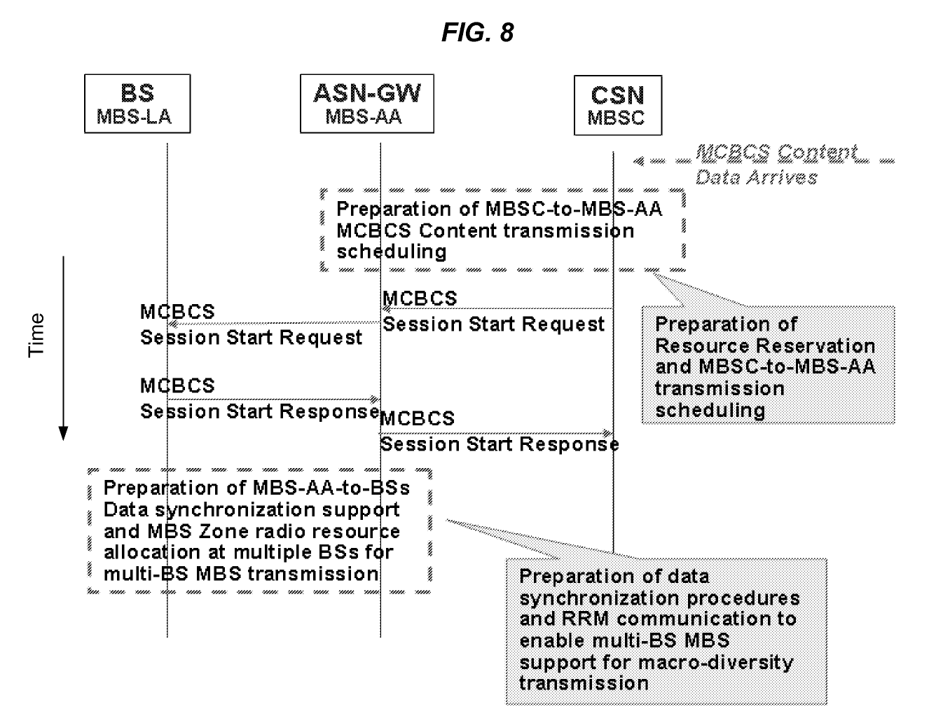

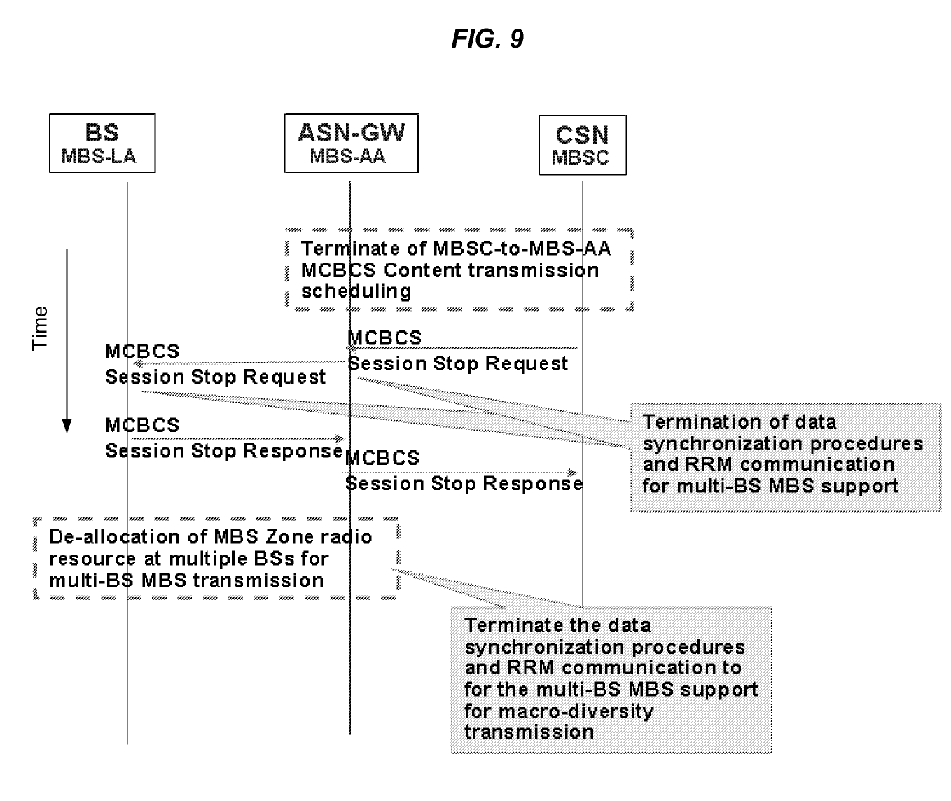

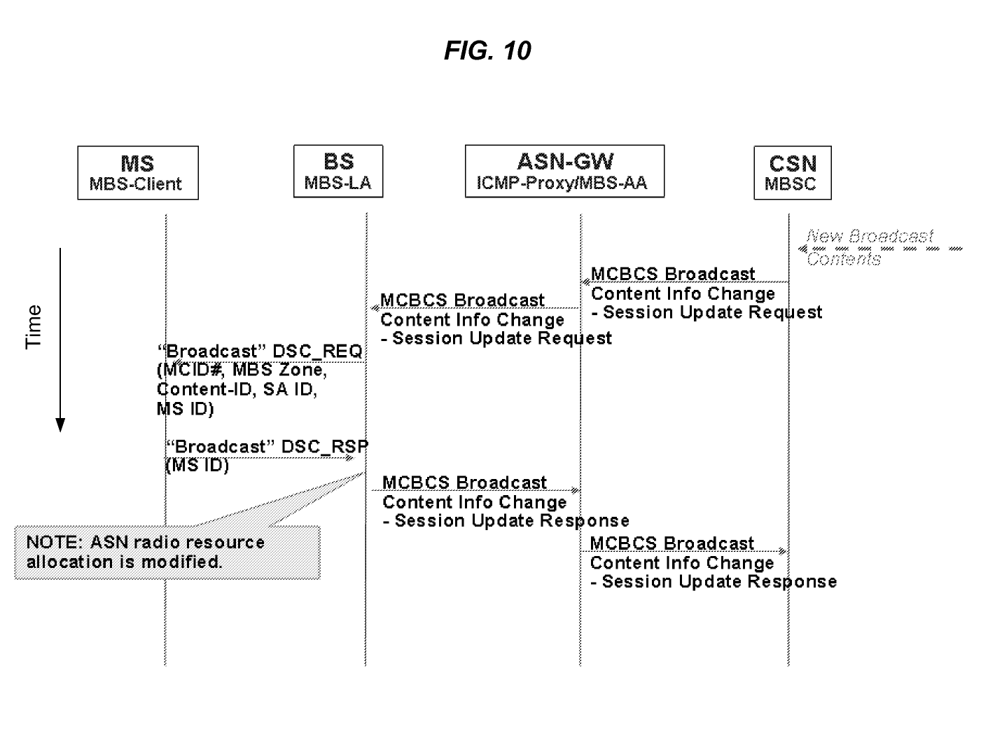

This section presents an overview of the MCBCS System Procedures. FIGS. 4 and 5 illustrate examples of MCBCS User Service Registration and De-registration Procedures. FIGS. 6 and 7 illustrate examples of MCBCS User Service Activation & De-activation Procedures. FIGS. 8 and 9 illustrate examples of MCBCS Content Transmission Session Start/Stop Procedures. FIG. 10 illustrates an example of MCBCS Content Transmission Session Update for Broadcast Mode ONLY.

### 8. Roaming Support for MCBCS User Services

Referring back to FIG. 1B, a visiting ASN may offer the support to a roaming user (MS) to access the MCBCS user services from the home or from the visiting network. The establishment of the Initial Service Flow (ISF) at the ASN for the given MS can be used to trigger the “join” procedure. The authorization for the MS to register to the MCBCS service at the visiting NSP is done by getting the permission from the home network of the MS. Once the MS is authorized by the home network, the MCBCS content can be transferred by the home NSP or by the visiting NSP network. Whether the MBSC is at the home CSN or the visiting CSN to be used based on the roaming policy or the agreement obtained between the visiting and the home NSPs, for example, the visited MBSC may allow to modify the information obtained from the home CSN based on the roaming policy and agreement between the NSPs. The example in FIG. 1B includes the roaming reference point between the home and the visiting networks.

### 9. MCBCS Data Synchronization Support During Switching Between Base Stations

A MBS-MS in the system in FIG. 1A or 1B in receiving a MCBCS service can switch from one base station to another base station without undergoing the normal handoff process in the unicast service for data or voice services. This “handoff-free” switching in the present system can be used to avoid the loss of continuous communication on the order of tens of ms (e.g., 50 ms to 100 ms) that is typically associated with the handoff process in unicast services.

One method to achieve this “handoff-free” switching in MCBCS service is to utilize the sychronication at the frame level in WiMAX communications. In this method, the MS is operated to synchronize the data reception based on the frame sequencing map in the frame header to provide an efficient MCBCS scheduling to delivery of the MCBCS contents synchronously to the MSs for the given MCBCS transmission zone. This MCBCS content synchronization refers to the operation of all BSs that are belonged to the same MCBCS Transmission Zone are all synchronized to transmit the same MCBCS content using the same TDD/FDD frame (i.e. frame level synchronization) and may be even synchronized in the same OFDMA data region using the same channel coding scheme (i.e. symbol level synchronization). The result of such precision of coordination function enables the macro diversity effect which provides a much higher transmission quality of the contents to the subscriber even at the cell edge of the coverage area.

The Macro Diversity Transport provides synchronciation at the symbol level. The WiMAX macro-diversity transport based on the spatial re-use can enhance the link budget of the BS(s) for the downlink transmission to reach to the MS at the cell edge. In such a scheme, the transmissions of the same information from multiple participating BSs are arranged such that they arrive at the MS at exactly the same time frame up to the accuracy at the OFDMA symbol level, thereby alleviating the requirement at the MS to detect multiple BSs in the same timeslot for the same or different frequency. As such, BSs are partitioned into transmission “groups” or “sets” and is called as “MCBCS Transmission Zone”. Each transmission zone is allocated a timeslot (or set of timeslots) for MCBCS transmission. The assigned slots are typically exclusively used by that MCBCS downstream transmission; zones do not transmit when another zone is active for the same carrier. The MS attempts to receive information within the zone and to combine them either at the physical layer in order to enhance reception reliability. To enable such accuracy of the transmission, the data synchronization and downlink transmission scheduling coordination between the MBS-AA and the MBS-LA are used to enable the macro diversity transport.

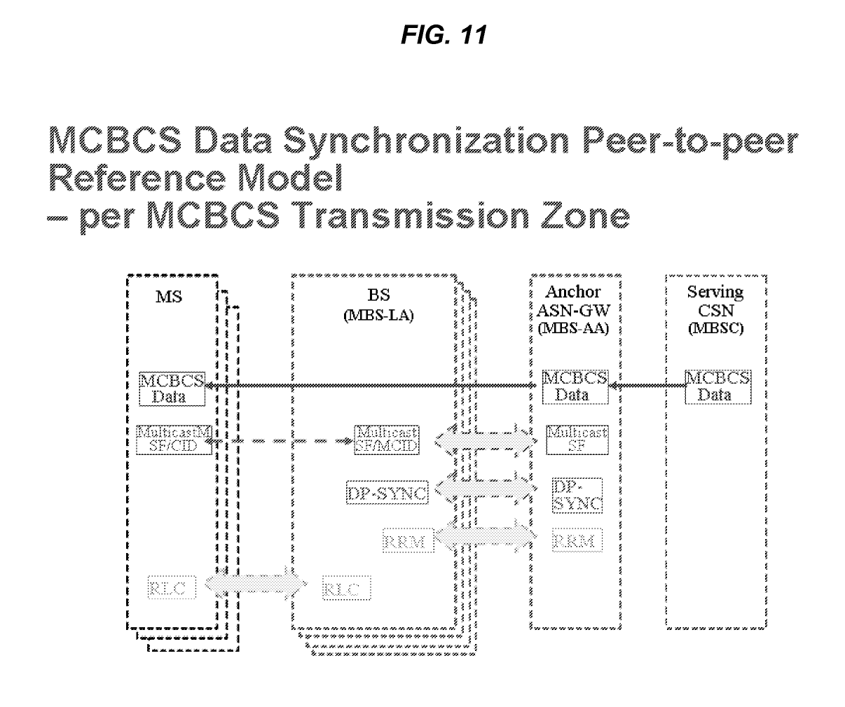

FIG. 11 shows an example of a peer-to-peer reference model to support the MCBCS data synchronization for a given MCBCS Transmission Zone.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, it is understood that variations and enhancements may be made.

What is claimed is:

1. A multicast broadcast service (MCBCS) WiMAX communication system, comprising:
at least one MCBCS access network (ASN) comprising (1) base stations to provide radio access to one or more MCBCS clients, and (2) an ASN gateway (ASN-GW) comprising at least one MCBCS Access Agent entity which provides signaling, establishing, and tearing down bearer channels for MCBCS clients, each base station comprising an MCBCS Local Agent entity to organize a respective local base station resource management function to support the MCBCS Access Agent entity to coordinate system resource allocation and airlink scheduling support;
at least one Connectivity Services Network (CSN) comprising a MCBCS controller that provides functions for MCBCS user service provisioning and delivery, a MCBCS subscriber profile manager that manages MCBCS subscriber profiles, a MCBCS subscriber profile database, and AAA functions that provide authentication, authorization and accounting functions; and
an interface in communication with one or more MCBCS content providers with MCBCS servers that serve MCBCS content data to the MCBCS controller.

2. The system as in claim 1, comprising:
a synchronization mechanism that synchronizes communications between a MCBCS client and base stations when switching the MCBCS client from one base station to another base station to continuously receive data of a requested MCBCS service without a handoff process.

3. The system as in claim 2, wherein:
the synchronization mechanism is based on a WiMAX micro-diversity transport synchronization between different base stations within a common transmission zone.

4. The system as in claim 2, wherein:
the synchronization mechanism is based on a frame-level synchronization between different base stations that transmit in a common TDD/FDD frame within a common transmission zone.

5. The system as in claim 1, comprising:
a roaming support mechanism in the CSN to allow a MCBCS client roaming outside the CSN to receive a MCBCS service via a different serving CSN to which the roaming MCBCS client is registered, wherein the different serving CSN communicates with the CSN to receive data on the roaming MCBCS client from the MCBCS user service provisioning and delivery, the MCBCS subscriber profile, and AAA functions.

6. A multicast broadcast service (MCBCS) WiMAX communication system, comprising:
at least one MCBCS access network (ASN) comprising (1) base stations to provide radio access to one or more MCBCS clients, (2) an ASN gateway (ASN-GW); (3) an MCBCS Access Agent entity which provides signaling, establishing, and tearing down bearer channels for MCBCS clients, and (4) an MCBCS Local Agent entity to organize a respective local base station resource management function to support the MCBCS Access Agent entity to coordinate system resource allocation and airlink scheduling support; and
a Connectivity Services Network (CSN) comprising a MCBCS controller that provides functions for MCBCS user service provisioning and delivery, a MCBCS subscriber profile manager that manages MCBCS subscriber profiles, a MCBCS subscriber profile database, and AAA functions that provide authentication, authorization and accounting functions, wherein the MCBCS controller delivers MCBCS content data to a MCBCS client requesting a MCBCS service.

7. The system as in claim 6, wherein:
the MCBCS controller is connected to one or more MCBCS content provider servers outside the CSN to retrieve MCBCS data and to deliver the received MCBCS data to serve a MCBCS client.

8. The system as in claim 6, wherein:
the CSN comprises one or more MCBCS content servers that store MCBCS content data; and
the MCBCS controller is connected to the one or more MCBCS content servers within the CSN to retrieve MCBCS data and to deliver the received MCBCS data to serve a MCBCS client.

9. The system as in claim 6, comprising:
a synchronization mechanism that synchronizes communications between a MCBCS client and base stations when switching the MCBCS client from one base station to another base station to continuously receive data of a requested MCBCS service without a handoff process.

10. The system as in claim 9, wherein:
the synchronization mechanism is based on a WiMAX micro-diversity transport synchronization between different base stations within a common transmission zone.

11. The system as in claim 9, wherein:
the synchronization mechanism is based on a frame-level synchronization between different base stations that transmit in a common TDD/FDD frame within a common transmission zone.

12. The system as in claim 6, comprising:
a roaming support mechanism in the CSN to allow a MCBCS client roaming outside the CSN to receive a MCBCS service via a different serving CSN to which the roaming MCBCS client is registered, wherein the different serving CSN communicates with the CSN to receive data on the roaming MCBCS client from the MCBCS user service provisioning and delivery, the MCBCS subscriber profile, and AAA functions.

13. The system as in claim 6, wherein:
the MCBCS Access Agent entity, the MCBCS Local Agent entity and the MCBCS controller are configured to provide a discovery process for a MCBCS client to discover a MCBCS service supported by the MCBCS controller and to provide direct communications between a MCBCS content provider server that provides MCBCS content data and the MCBCS client.

14. The system as in claim 6, wherein:
the MCBCS Access Agent entity, the MCBCS Local Agent entity and the MCBCS controller are configured to further support MCBCS services under 3 GPP2 in addition to MCBCS services under WiMAX.
